(19) United States
(12) Patent Application Publication
(10) Pub. No.: US 2016/0334983 A1
(43) Pub. Date: Nov. 17, 2016

(54) Two-Dimensional and Multi-Threshold Elastic Button User Interface System and Method

(71) Applicant: Sang Baek LEE, Sunnyvale, CA (US)

(72) Inventor: Sang Baek LEE, Sunnyvale, CA (US)

(21) Appl. No.: 14/730,089

(22) Filed: Jun. 3, 2015

(30) Foreign Application Priority Data
May 14, 2015 (KR) 10-2015-0067257

(51) Int. Cl. G06F 3/0488; H04N 5/232; G06F 3/041; G06F 3/0482; G06F 3/0484

(52) U.S. Cl. CPC G06F 3/04883; G06F 3/0482; G06F 3/04845; G06F 3/0412; G06F 3/0416; G06F 3/04886; G06F 3/04842; G06F 3/04847; H04N 5/23216; H04N 5/23293

(57) ABSTRACT

A novel elastic button user interface system and a related method of operation are disclosed. In one embodiment, the elastic button user interface system generates an elastic button that simulates physical characteristics of a button suspended on an elastic string on a touch-sensing display unit. The elastic button first allows selection of a particular item from a display menu, and invokes dynamic transformations to the particular item by correlating a user-induced horizontal and/or vertical movement of the elastic button with application-specific design parameters for two-dimensional and multiple-level thresholds for the elastic button user interface system. Furthermore, releasing the elastic button by removing a finger from the elastic button triggers a “final activation” for the particular item, after dynamic transformations to the particular item during the user-induced movement of the elastic button. Examples of the final activation includes activating a camera shutter and transmitting a message to another electronic device.

### BACKGROUND OF THE INVENTION

The present invention generally relates to electronic user interfaces. More specifically, the invention relates to an elastic button user interface system and a related method of operation in an electronic device.

Pervasive utilization of touchscreen-enabled electronic devices in recent years has ushered in an era of virtualized buttons and keyboards, especially for smart phones and other portable electronic devices. Unlike physical buttons and keyboards, virtualized touch-sensitive buttons and keyboards provide flexibility of optimizing a limited display screen real estate, and also enable customized user interface experience with application-specific varying button and keyboard sizes and shapes, depending on a need of a particular mobile application.

In some instances, the virtualized touch-sensitive buttons and keyboards also utilize the concept of “gesture navigation,” which requires a user to perform a continuous “onscreen drag” finger movement to draw a particular shape on a touchscreen-enabled electronic device, which is then recognized as a specific command by the touchscreen-enabled electronic device. For example, on a “BlackBerry 10” smart phone device, a user's finger gesture involving an upward-then-rightward finger drag movement during any active states of the device operation will invoke the “BlackBerry Hub,” which is a unified messaging center for the user's email accounts, social networking accounts, text messages, and voicemail. In another example, several smart phone operating systems recognize a downward finger drag from the top of a touchscreen as invoking a dropdown menu for device settings.

As more functions, commands, and gestures get integrated into touchscreen-enabled electronic devices, user interactions with the touchscreen-enabled devices also become more complicated and less intuitive. Therefore, it may be desirable to provide a novel user interface system that can perform a multiple number of tasks with a coherent sequence of intuitive finger gestures. Furthermore, it may be desirable to create the coherent sequence of intuitive finger gestures by simulating a fluid and elastic motion of a button suspended on an elastic string. In addition, it may also be desirable to provide a method of operating the novel user interface system implemented in an electronic device.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In one embodiment of the invention, an elastic button user interface system is disclosed. This elastic button user interface system comprises: a touch-sensing display unit; one or more touch-detecting sensors embedded in the touch-sensing display unit; a touch sensor output interpretation interface operatively connected to the touch-sensing display unit; a graphics unit operatively connected to the touch sensor output interpretation interface and the touch-sensing display unit; and an elastic button user interface system module operatively connected to the graphics unit, the touch sensor output interpretation interface, and the touch-sensing display unit, wherein the elastic button user interface system module creates, adjusts, and manages an elastic button user interface comprising an anchoring menu button, an elastic string anchored by the anchoring menu button, an elastic button suspended on the elastic string, and one or more vertical and horizontal distance action thresholds that trigger user commands to an electronic application environment that integrated the elastic button user interface when the elastic button is dragged or released by a user's finger on the touch-sensing display unit.

In another embodiment of the invention, a method of operating an elastic button user interface system is disclosed. This method comprises the steps of: generating an elastic button user interface from an elastic button user interface system module and a graphics unit incorporated in the elastic button user interface system by creating an anchoring menu button, an elastic string anchored by the anchoring menu button, and an elastic button suspended on the elastic string on a touch-sensing display unit; creating, with the elastic button user interface system module, two-dimensional vertical and horizontal action thresholds for the elastic button user interface by synchronizing user interface parameters for a particular electronic application in the elastic button user interface system; allowing a user to select an item from the touch-sensing display unit; allowing the user to drag the elastic button suspended on the elastic string; detecting, with touch-detecting sensors embedded in the touch-sensing display unit and the elastic button user interface system module, a vertical distance and a horizontal distance moved by the elastic button before the user's finger release; dynamically changing a size or shape of the item or magnification parameters of a displayed image on the touch-sensing display unit by comparing the two-dimensional vertical and horizontal action thresholds against the vertical distance and the horizontal distance moved by the elastic button before the user's finger release; and if the user's finger release is detected by the touch-detecting sensors and the elastic button user interface systems module, triggering a final activation for the item.

### BRIEF DESCRIPTION OF DRAWINGS

FIG. 1 shows an elastic button user interface of an electronic device, with an elastic button pulled downward but not reaching a first action threshold, in accordance with an embodiment of the invention.

FIG. 2 shows an elastic button user interface of an electronic device, with an elastic button pulled downward and reaching a first action threshold (i.e. enabling picture taking upon release of the elastic button), in accordance with an embodiment of the invention.

FIG. 3 shows an elastic button user interface of an electronic device, with an elastic button pulled further downward to a second action threshold, which activates a camera zoom-in and also enables picture taken upon release of the elastic button, in accordance with an embodiment of the invention.

FIG. 4 shows a screenshot after an elastic button is released from an elastic button user interface on an electronic device, wherein the elastic button release invokes capturing a photograph of a currently-displayed image from a camera controlled by a dragged movement of the elastic button prior to release, in accordance with an embodiment of the invention.

FIG. 5 shows first four sequences (i.e. Sequence A1˜Sequence A4) for utilizing an elastic button user interface prior to an elastic button release in a first messaging application environment, in accordance with an embodiment of the invention.

FIG. 6 shows a last sequence (i.e. Sequence A5) for utilizing the elastic button user interface in the first messaging application environment after the elastic button release, in accordance with an embodiment of the invention.

FIG. 7 shows first and second sequences (i.e. Sequence B1, Sequence B2) for utilizing an elastic button user interface prior to an elastic button release in a second messaging application environment, in accordance with an embodiment of the invention.

FIG. 8 shows third and fourth sequences (i.e. Sequence B3, Sequence B4) for utilizing the elastic button user interface prior to the elastic button release in the second messaging application environment, in accordance with an embodiment of the invention.

FIG. 9 shows a fifth sequence (i.e. Sequence B5) for utilizing the elastic button user interface prior to the elastic button release, and also shows a last sequence (i.e. Sequence B6) for utilizing the elastic button user interface in the second messaging application environment after the elastic button release, in accordance with an embodiment of the invention.

FIG. 10 shows a hardware system block diagram for an elastic button user interface system, in accordance with an embodiment of the invention.

FIG. 11 shows a method of operating an elastic button user interface system, in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of procedures, logic blocks, processing, and/or other symbolic representations that directly or indirectly resemble one or more elastic button user interface systems and related methods of operation. These process descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order nor imply any limitations in the invention.

For the purpose of describing the invention, a term “camera” is defined as an electronic device with a camera lens that can capture pictures, videos, and/or other multimedia information through the camera lens. Typically, a camera is connected to or integrated into a portable electronic device, which can process and store the captured pictures, videos, and/or other multimedia information in standardized multimedia formats.

In addition, for the purpose of describing the invention, a term “elastic” is defined as exhibiting flexible or stretchable characteristics when pulled and also exhibiting at least some recoil (i.e. tendency to return to an original position or length) upon release. For example, an “elastic button” may be a user interface button suspended on one or more virtualized elastic strings that provide elastic qualities to the user interface button. In another example, an elastic button user interface may be called a “slingshot interface,” if the elastic button user interface resembles a slingshot, with an elastic button resembling a stone catapulted by an elastic band.

Furthermore, for the purpose of describing the invention, a term “elastic button user interface system” is defined as a special-purpose, application-specific, or another type of electronic device that integrates one or more touch-detecting sensors embedded in a touch-sensing display unit, a touch sensor output interpretation interface unit, an elastic button user interface system module, a graphics unit, and other necessary or desired components.

In general, one or more embodiments of the invention relate to providing a novel user interface system that can perform a multiple number of tasks with a coherent sequence of intuitive finger gestures on an elastic button user interface. In some embodiments of the invention, the elastic button user interface may resemble a slingshot, with an elastic button resembling a stone catapulted by an elastic band.

Furthermore, one or more embodiments of the invention also relate to providing a coherent sequence of intuitive finger gestures in a novel user interface system by electronically simulating a fluid and elastic motion of a button suspended on an elastic string.

In addition, one or more embodiments of the invention also relate to a method of operating a novel elastic button user interface system implemented in an electronic device.

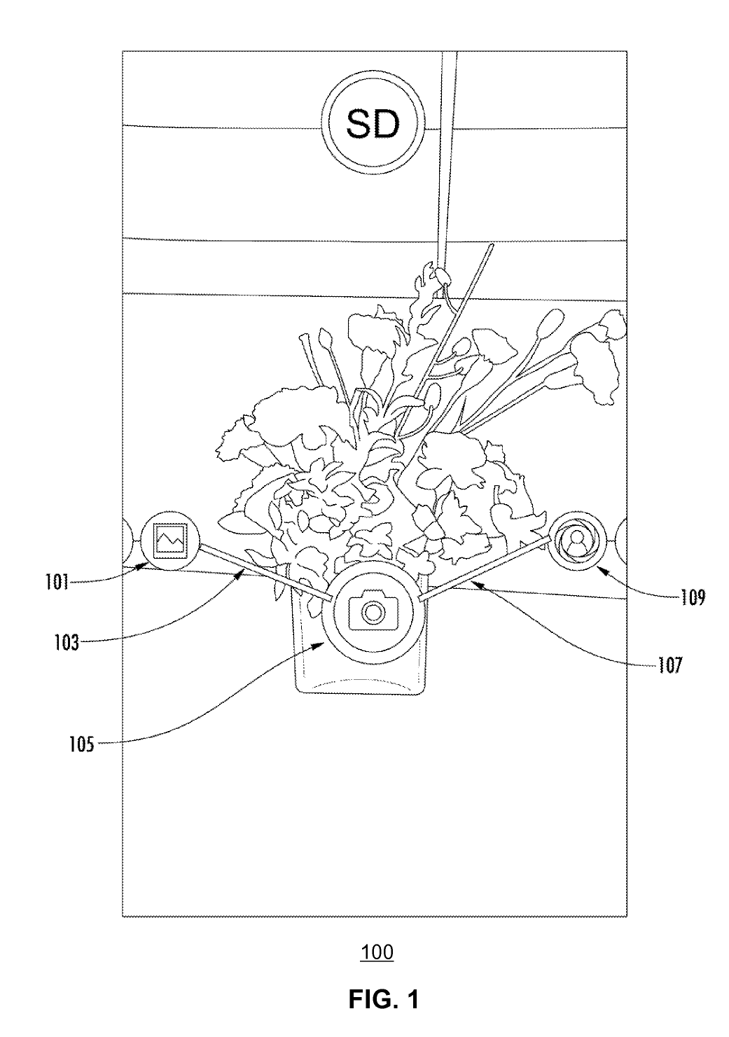

FIG. 1 shows a first sequence screenshot of an elastic button user interface (100) from an electronic device, with an elastic button (105) pulled downward but not reaching a first action threshold, in accordance with an embodiment of the invention. In this embodiment of the invention, the elastic button user interface (100) is incorporated into a digital camera viewfinder functionality of the electronic device. This electronic device is configured to incorporate a touch-sensing display unit, one or more touch-detecting sensors, a touch sensor output interpretation interface, and an elastic button user interface system module. The electronic device may be a smart phone, a tablet computer, or a specialized application-specific portable electronic device custom-built for integration of the elastic button user interface with a touch-sensing display unit, one or more touch-detecting sensors, a touch sensor output interpretation interface, and a specialized elastic button user interface system module.

In the first sequence screenshot as shown in FIG. 1, the elastic button user interface (100) comprises the elastic button (105) suspended on a first elastic string (103) and a second elastic string (107). Preferably, the first elastic string (103) is anchored by a first anchoring menu button (101), and the second elastic string (107) is anchored by a second anchoring menu button (109). Each anchoring menu button (101, 109) may be a functional button that triggers a specific user command. For example, in the first sequence screenshot as shown in FIG. 1, pressing the first anchoring menu button (101) may bring up a photo display menu, and pressing the second anchoring menu button (109) may act as a camera shutter button.

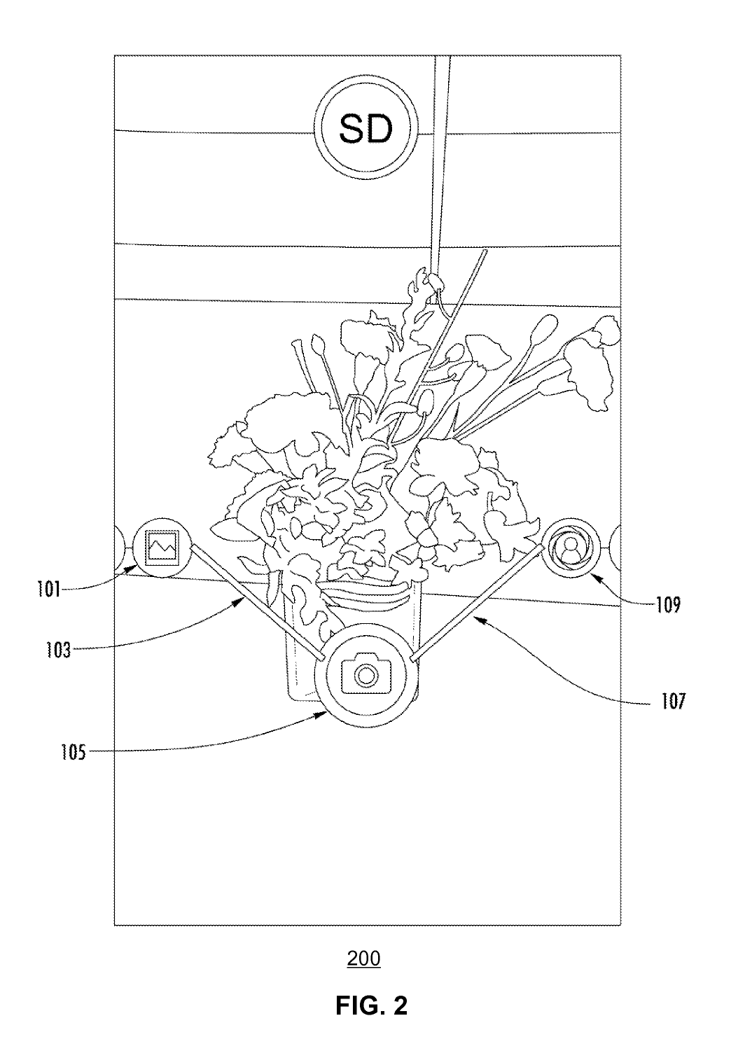

The elastic strings (103, 107) that are anchored by the anchoring menu buttons (101, 109) provide virtualized elasticity to the elastic button (105) on a touch-sensing display unit, which is incorporated into the electronic device. In the first sequence screenshot as shown in FIG. 1, the elastic button (105) is slightly dragged and/or pulled downward by a user's finger on the touch-sensing display unit, and has not yet reached the first action threshold, which is subsequently explained in association with FIG. 2. Because the first action threshold is not yet reached in the first sequence screenshot in FIG. 1, releasing the elastic button (105) from the user's finger may not trigger a particular user command as an action. Instead, the elastic button (105) can simply recoil back to its equilibrium position (i.e. forming a horizontal line with the elastic strings (103, 107) and the anchoring menu buttons (101, 109)).

FIG. 2 shows a second sequence screenshot of an elastic button user interface (200) of an electronic device, with an elastic button (105) pulled downward and reaching a first action threshold (i.e. enabling picture taking upon release of the elastic button), in accordance with an embodiment of the invention. As a subsequent sequence following the first sequence depicted in FIG. 1, the elastic button user interface (200) is incorporated into the digital camera viewfinder functionality of the electronic device.

In the second sequence screenshot as shown in FIG. 2, the elastic button user interface (200) still includes the elastic button (105) suspended on the first elastic string (103) and the second elastic string (107). Furthermore, the first elastic string (103) continues to be anchored by the first anchoring menu button (101), and the second elastic string (107) continues to be anchored by the second anchoring menu button (109). Similar to the functionality of the elastic button user interface (i.e. 100) in the first sequence, each anchoring menu button (101, 109) may be a functional button that triggers a specific user command. For example, in the second sequence screenshot as shown in FIG. 2, pressing the first anchoring menu button (101) may bring up a photo display menu, and pressing the second anchoring menu button (109) may act as a camera shutter button.

In the second sequence of the elastic button user interface (200), the elastic strings (103, 107) that are anchored by the anchoring menu buttons (101, 109) continue to provide the virtualized elasticity to the elastic button (105) on the touch-sensing display unit, which is incorporated into the electronic device. In the second sequence screenshot as shown in FIG. 2, the elastic button (105) is dragged and/or pulled further downward relative to the first sequence in FIG. 1 by the user's finger on the touch-sensing display unit to reach the first action threshold. In a preferred embodiment of the invention, the first action threshold may be defined by a vertical and/or horizontal distance between an initial position and a current position of the elastic button (105).

When the elastic button (105) is dragged by a user's finger and reaches a preset distance (i.e. distance between the initial position and the current position of the elastic button (105)) that meets or exceeds the first action threshold, releasing the elastic button (105) from the current position triggers a particular user command to the electronic device. For example, the particular user command can be issued by releasing the elastic button (105) at or beyond the first action threshold. In context of the digital camera viewfinder example as shown in FIG. 2, releasing the elastic button (105) at the second sequence screenshot can trigger a camera shutter button activation. In another embodiment of the invention, releasing the elastic button (105) at the second sequence screenshot may trigger another device command, such as activating a camera flash, turning on an image stabilization mode, or another desired feature configured and implemented by a elastic button user interface designer for a particular application or device.

In the preferred embodiment of the invention, if the user released his or her finger from the elastic button (105) at the moment shown in the second sequence screenshot, the elastic button (105) will trigger the particular user command to the electronic device, and then return or recoil back to its initial or equilibrium position (i.e. forming a horizontal line with the elastic strings (103, 107) and the anchoring menu buttons (101, 109)).

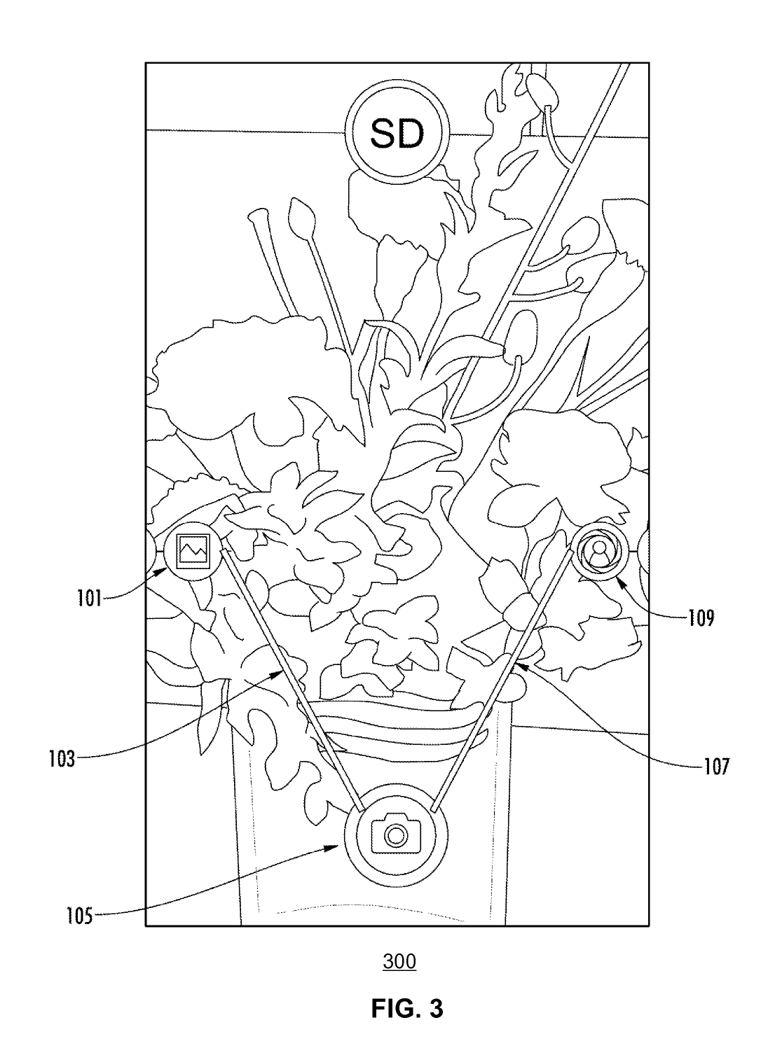

FIG. 3 shows a third sequence screenshot of an elastic button user interface (300) of an electronic device, with an elastic button pulled further downward to a second action threshold, which activates a camera zoom-in and also enables picture taken upon release of the elastic button, in accordance with an embodiment of the invention. As a subsequent sequence following the second sequence depicted in FIG. 2, the elastic button user interface (300) is incorporated into the digital camera viewfinder functionality of the electronic device.

In the third sequence screenshot as shown in FIG. 3, the elastic button user interface (300) still includes the elastic button (105) suspended on the first elastic string (103) and the second elastic string (107). Furthermore, the first elastic string (103) continues to be anchored by the first anchoring menu button (101), and the second elastic string (107) continues to be anchored by the second anchoring menu button (109). Similar to the functionality of the elastic button user interface (i.e. 100, 200) in the first sequence and the second sequence, each anchoring menu button (101, 109) may be a functional button that triggers a specific user command. For example, in the third sequence screenshot as shown in FIG. 3, pressing the first anchoring menu button (101) may bring up a photo display menu, and pressing the second anchoring menu button (109) may act as a camera shutter button.

In the third sequence of the elastic button user interface (300), the elastic strings (103, 107) that are anchored by the anchoring menu buttons (101, 109) continue to provide the virtualized elasticity to the elastic button (105) on the touch-sensing display unit, which is incorporated into the electronic device. In the third sequence screenshot as shown in FIG. 3, the elastic button (105) is dragged and/or pulled further downward relative to the second sequence in FIG. 2 by the user's finger on the touch-sensing display unit to reach the second action threshold. In a preferred embodiment of the invention, the second action threshold may be defined by a vertical and/or horizontal distance between a first action threshold position and a current position of the elastic button (105). Alternatively, the second action threshold may be defined by a vertical and/or horizontal distance between an initial position and a current position of the elastic button (105).

When the elastic button (105) is dragged by a user's finger and reaches a preset distance that meets or exceeds the second action threshold, releasing the elastic button (105) from the current position triggers a particular user command to the electronic device. This particular user command is typically different from a user command associated with the first action threshold. For example, the second action threshold may be associated with a camera magnification or “zoom-in” command for the camera viewfinder, wherein the camera “zoom-in” command is activated as the current position of the elastic button (105) exceeds the second action threshold. In context of the digital camera viewfinder example as shown in FIG. 3, dragging the elastic button (105) further down beyond the second action threshold may correspondingly increase the magnitude of the zoom-in, which is illustrated in FIG. 3. Moreover, subsequently dragging the elastic button (105) slightly upward towards the second action threshold again may correspondingly decrease the magnitude of the zoom-in.

Furthermore, in the preferred embodiment of the invention, releasing the elastic button (105) after meeting or exceeding the second action threshold can also trigger a camera shutter button activation. In another embodiment of the invention, releasing the elastic button (105) at the third sequence screenshot may trigger another device command, such as activating a camera flash, turning on an image stabilization mode, or another desired feature configured and implemented by a elastic button user interface designer for a particular application or device.

In the preferred embodiment of the invention, if the user released his or her finger from the elastic button (105) at the moment shown in the third sequence screenshot, the elastic button (105) will trigger the particular user command to the electronic device, and then return or recoil back to its initial or equilibrium position (i.e. forming a horizontal line with the elastic strings (103, 107) and the anchoring menu buttons (101, 109)).

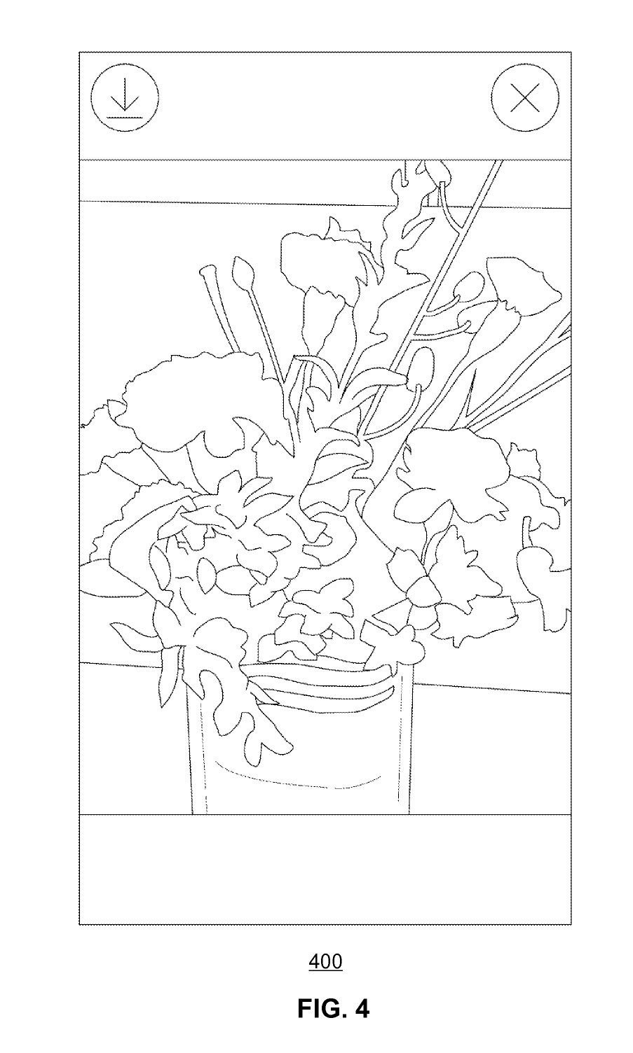

FIG. 4 shows a screenshot (400) after an elastic button is released from an elastic button user interface on an electronic device, wherein the elastic button release invokes capturing a photograph of a currently-displayed image from a camera controlled by a dragged movement of the elastic button prior to release, in accordance with an embodiment of the invention. The screenshot (400) in FIG. 4 shows a final sequence following the third sequence of the elastic button user interface (300) shown in FIG. 3. This final sequence is triggered by the release of the elastic button from the user's finger on the touch-sensing display unit. When the elastic button is released from the user's finger, a “final activation” user command is invoked through the elastic button user interface executed in the electronic device.

The final activation user command is typically predefined and implemented by a user interface designer prior to integration of the elastic button user interface to the electronic device. However, in some embodiments of the invention, the user may be able to customize a desired user command and associate the customized user command with the user's finger release from the elastic button. In the embodiment of the invention as shown in the screenshot (400) in FIG. 4, the final activation user command (i.e. triggered by the release of the elastic button) is activating a camera shutter button, or capturing a photograph of a currently-displayed image from a camera integrated into or associated with the electronic device.

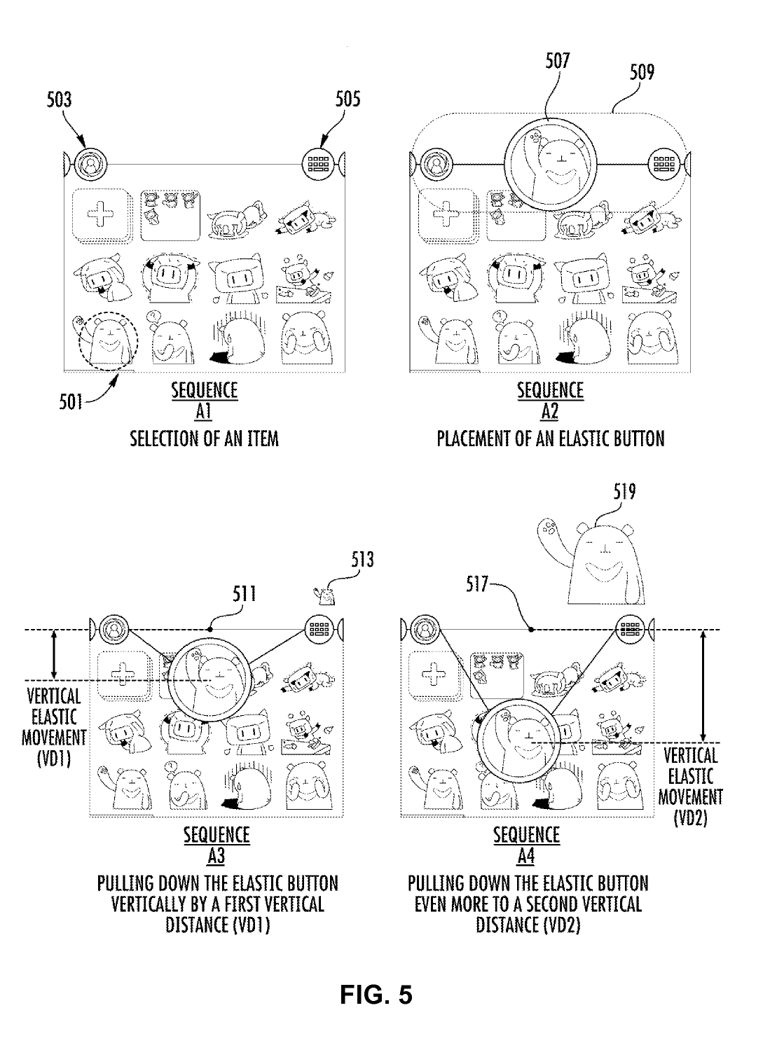

FIG. 5 shows first four sequences (i.e. Sequence A1˜Sequence A4) for utilizing an elastic button user interface prior to an elastic button release in a first messaging application environment, in accordance with an embodiment of the invention. The first messaging application environment is configured to operate in an electronic device that incorporates a touch-sensing display unit, one or more touch-detecting sensors, a touch sensor output interpretation interface, and an elastic button user interface system module. The electronic device may be a smart phone, a tablet computer, or a specialized application-specific portable electronic device custom-built for integration of the elastic button user interface with a touch-sensing display unit, one or more touch-detecting sensors, a touch sensor output interpretation interface, and a specialized elastic button user interface system module.

In this embodiment of the invention, the elastic button user interface is utilized in a messaging application environment implemented in an electronic device with a touch-sensing display unit. “Sequence A1” in FIG. 5 shows a user selection of an item (501), which may be an icon or another graphical object. When the item (501) is selected, a perforated circle may be created around the item (501) to indicate the item selection, as shown in FIG. 5. Alternatively, in another embodiment, the item (501) may be highlighted or colored differently from other items in the item menu. As also shown in “Sequence A1,” a first anchoring menu button (503) and a second anchoring menu button (505) may appear in the elastic button user interface, but these anchoring menu buttons (503, 505) do not yet have strings or an elastic button suspended on the strings.

In a subsequent sequence, the elastic button user interface creates the elastic button (507), a first string connecting the elastic button (507) and the first anchoring menu button (503), and a second string connecting the elastic button (507) and the second anchoring menu button (505), as shown in “Sequence A2” in FIG. 5. Furthermore, the elastic button user interface in “Sequence A2” also includes a graphical representation of the item (501) selected from “Sequence A1” as an icon inside the elastic button (507). In an initial or equilibrium state of the elastic button user interface, the elastic button (507) typically forms a straight line with the first string, the second string, the first anchoring menu button (503), and the second anchoring menu button (505), as shown inside an elliptical area (509) for illustration purposes.

Then, as shown in “Sequence A3,” a user's finger drags and pulls down the elastic button (507) vertically by a first vertical distance (VD1) from an initial or equilibrium position (511). In this particular sequence, the first vertical distance (VD1) for the elastic button (507) met or exceeded a first action threshold, which triggers a user command to create a small-size representation (513) of the item (501) on an upper display section. Subsequently, as the user's finger drags and pulls down the elastic button (507) further to a second vertical distance (VD2), what was initially the small-size representation (513) of the item (501) on the upper display section in the elastic button user interface in “Sequence A3” becomes enlarged to a large-size representation (519) of the item (501) in “Sequence A4”. In a preferred embodiment of the invention, the size of the graphical representation (e.g. 513, 519) of the item (501) on the upper display section is directly proportional to the difference between the first vertical distance (VD1) and the second vertical distance (VD2). In another embodiment of the invention, the second vertical distance (VD2) may instead trigger another action threshold for another user command associated with the electronic device.

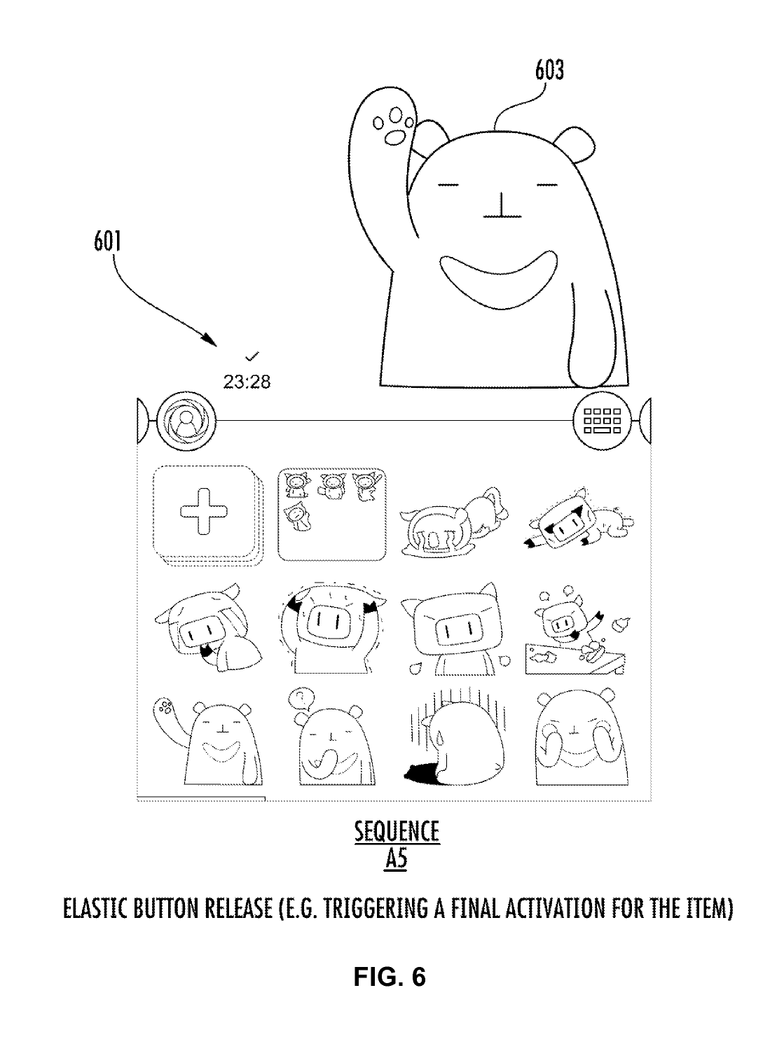

FIG. 6 shows a last sequence, or “Sequence A5,” for utilizing the elastic button user interface in the first messaging application environment after the elastic button release, in accordance with an embodiment of the invention. Once the user's finger releases the elastic button (507 of FIG. 5) on the touch-sensing display unit, a “final activation” user command is invoked through the elastic button user interface executed in the electronic device. In case of the first messaging application environment, the final activation user command is an actual transmission of the item (501 of FIG. 5) whose size was dynamically controlled by a vertical distance (i.e. VD1, VD2 in FIG. 5) of the elastic button (507 of FIG. 5) until the release of the elastic button.

As shown in FIG. 6, a finalized size (603) of the item (501 of FIG. 5) for the actual transmission to another electronic device is determined by the last position of the elastic button (507 of FIG. 5) prior to its release. Because the finalized size (603) is substantially enlarged relative to the initial size of the item (501 of FIG. 5) originally selected by the user, the last position of the elastic button (507 of FIG. 5) must have exceeded the first vertical distance (VD1) significantly, as previously shown in “Sequence A4.” When the actual transmission of the item (501 of FIG. 5) with the finalized size (603) is completed to another electronic device, the first messaging application environment that integrated the elastic button user interface displays a checkmark (601) with a timestamp (e.g. “23:28”) to indicate a successful transmission of the message containing the finalized size (603) of the item (501 of FIG. 5).

The final activation user command, which is a user command to transmit a selected message in this embodiment, is typically predefined and implemented by a user interface designer prior to integration of the elastic button user interface to the electronic device. However, in some embodiments of the invention, the user may be able to customize a desired user command and associate the customized user command with the user's finger release from the elastic button.

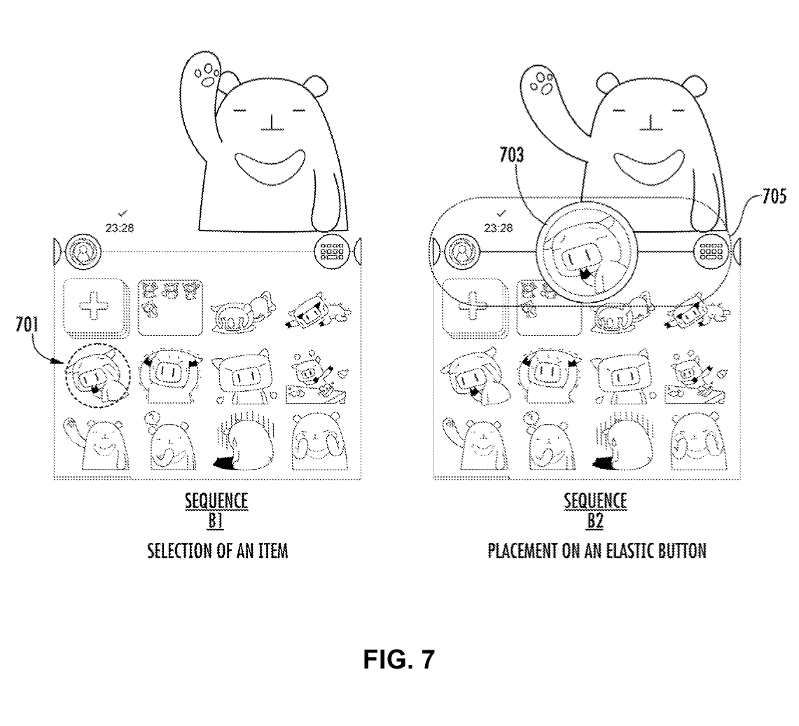

FIG. 7 shows first and second sequences (i.e. Sequence B1, Sequence B2) for utilizing an elastic button user interface prior to an elastic button release in a second messaging application environment, in accordance with an embodiment of the invention. The second messaging application environment is configured to operate in an electronic device that incorporates a touch-sensing display unit, one or more touch-detecting sensors, a touch sensor output interpretation interface, and an elastic button user interface system module. The electronic device may be a smart phone, a tablet computer, or a specialized application-specific portable electronic device custom-built for integration of the elastic button user interface with a touch-sensing display unit, one or more touch-detecting sensors, a touch sensor output interpretation interface, and a specialized elastic button user interface system module.

In this embodiment of the invention, the elastic button user interface is utilized in a messaging application environment implemented in an electronic device with a touch-sensing display unit. As shown in the upper display area of the elastic button user interface, the enlarged bear icon (i.e. 603 in FIG. 6) already transmitted as a message and the checkmark (i.e. 601 in FIG. 6) with the timestamp (i.e. “23:28”) suggest that the screenshots for “Sequence B1”˜“Sequence B6” of the second messaging application environment in FIGS. 7˜9 follow the last sequence (i.e. “Sequence A5”) of the first messaging application environment, which are previously described in association with FIGS. 5˜6.

As shown in FIG. 7, “Sequence B1” shows a user selection of an item (701), which may be an icon or another graphical object. When the item (701) is selected, a perforated circle may be created around the item (701) to indicate the item selection, as shown in FIG. 7. Alternatively, in another embodiment, the item (701) may be highlighted or colored differently from other items in the item menu. As also shown in “Sequence B1,” a first anchoring menu button and a second anchoring menu button may appear in the elastic button user interface, but these anchoring menu buttons do not yet have strings or an elastic button suspended on the strings.

In a subsequent sequence, the elastic button user interface creates the elastic button (703), a first string connecting the elastic button (703) and the first anchoring menu button, and a second string connecting the elastic button (703) and the second anchoring menu button, as shown in “Sequence B2” in FIG. 7. Furthermore, the elastic button user interface in “Sequence B2” also includes a graphical representation of the item (701) selected from “Sequence B1” as an icon inside the elastic button (703). In an initial or equilibrium state of the elastic button user interface, the elastic button (703) typically forms a straight line with the first string, the second string, the first anchoring menu button, and the second anchoring menu button, as shown inside an elliptical area (705) for illustration purposes.

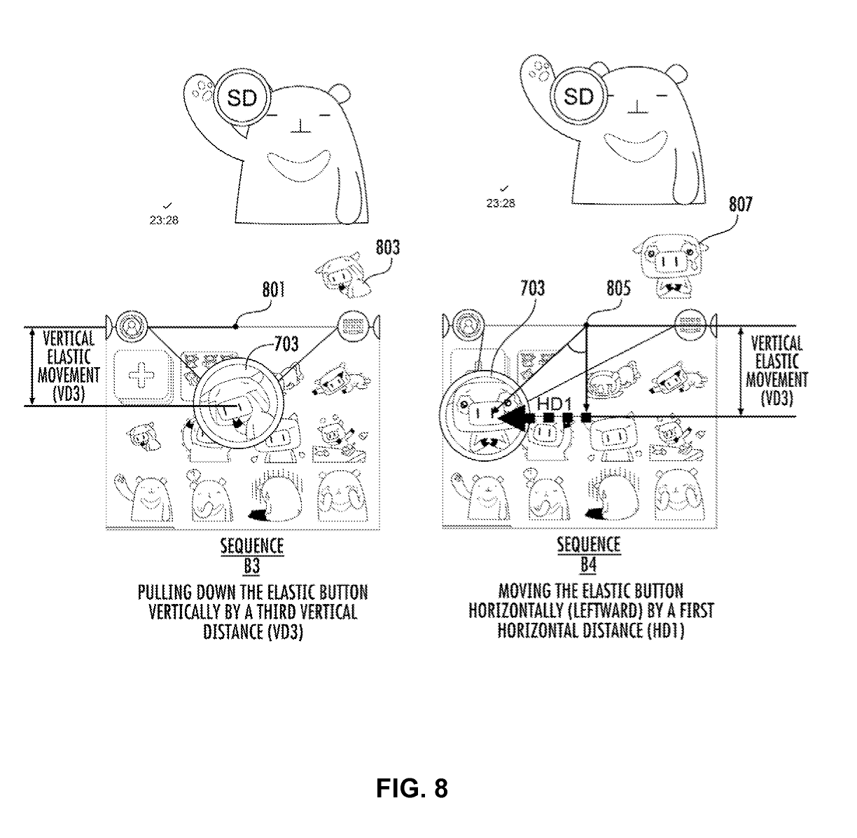

FIG. 8 shows third and fourth sequences (i.e. Sequence B3, Sequence B4) for utilizing the elastic button user interface prior to the elastic button release in the second messaging application environment, in accordance with an embodiment of the invention. After undergoing the previous two sequences (i.e. Sequence B1, Sequence B2), a user's finger drags and pulls down the elastic button (703) vertically by a third vertical distance (VD3) from an initial or equilibrium position (801) in “Sequence B3.” In this particular sequence, the third vertical distance (VD3) for the elastic button (703) met or exceeded a first action threshold, which triggers a user command to create a small-size representation (803) of the item (701 in FIG. 7) on an upper display section.

Subsequently, as the user's finger drags the elastic button (703) leftward to a first horizontal distance (HD1) in “Sequence B4,” an animal facial expression or shape in the item (701 in FIG. 7) undergoes changes, as depicted inside the elastic button (703) itself and also in a dynamically-changing size representation (807) of the item (701 in FIG. 7) on the upper display section in this particular embodiment of the invention. In this example as shown in “Sequence B4,” the leftward horizontal dragging of the elastic button (703) triggers a facial expression or shape transformation command, while the downward vertical dragging of the elastic button (703) triggers a size change command for the dynamically-changing size representation (807) of the item (701 in FIG. 7). The transformation of the animal facial expression or the animal shape may vary directly with a changing angle (805) caused by an increase or a decrease in the first horizontal distance (HD1). In another embodiment of the invention, the changing angle (805) caused by the increase or the decrease in the first horizontal distance (HD1) may trigger another action threshold for another user command associated with the electronic device.

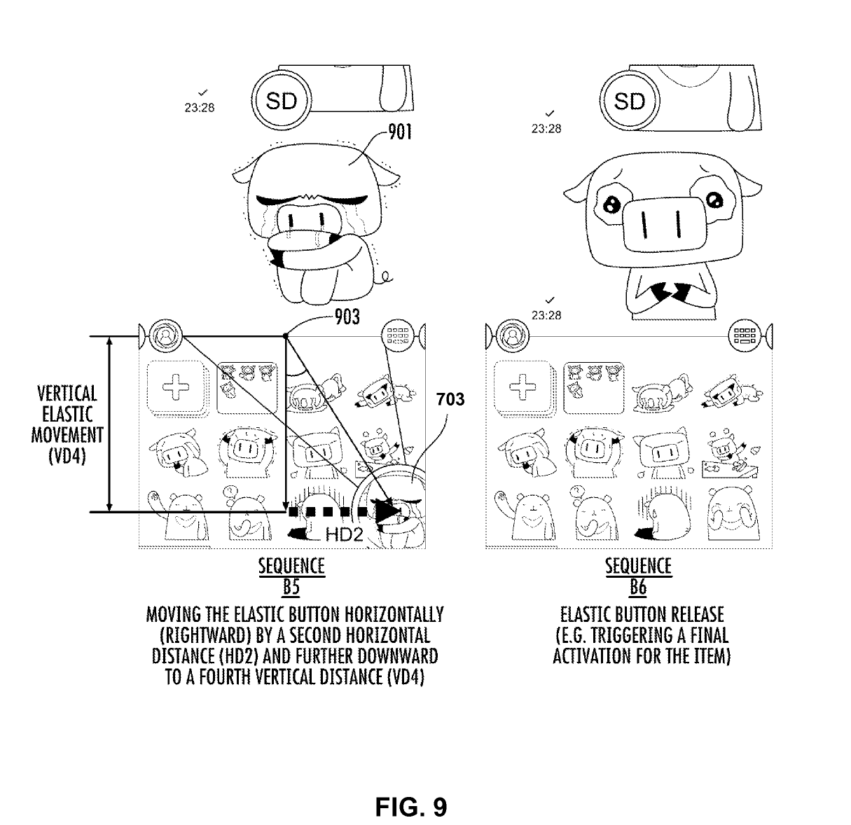

FIG. 9 shows a fifth sequence (i.e. Sequence B5) for utilizing the elastic button user interface prior to the elastic button release, and also shows a last sequence (i.e. Sequence B6) for utilizing the elastic button user interface in the second messaging application environment after the elastic button release, in accordance with an embodiment of the invention. In “Sequence B5,” which follows the previously-described “Sequence B4,” the user's finger drags the elastic button (703) far to the right and also downward to the bottom right corner of the elastic button user interface. The dragging of the elastic button (703) in “Sequence B5” can be measured in terms of a second horizontal distance (HD2) and a fourth vertical distance (VD4), as graphically shown in FIG. 9.

As the user's finger drags the elastic button (703) far to the right to the second horizontal distance (HD2) in “Sequence B5,” an animal facial expression or shape in the item (701 in FIG. 7) undergoes changes, as depicted inside the elastic button (703) itself and also in a dynamically-changing size representation (901) of the item (701 in FIG. 7) on the upper display section in this particular embodiment of the invention. In this example as shown in “Sequence B5,” the rightward horizontal dragging of the elastic button (703) triggers a facial expression or shape transformation command, while the downward vertical dragging of the elastic button (703) triggers a size change command for the dynamically-changing size representation (901) of the item (701 in FIG. 7). The transformation of the animal facial expression or the animal shape may vary directly with a changing angle (903) caused by an increase or a decrease in the second horizontal distance (HD2). In another embodiment of the invention, the changing angle (903) caused by the increase or the decrease in the second horizontal distance (HD2) may trigger another action threshold for another user command associated with the electronic device.

FIG. 9 also shows the last sequence, or “Sequence B6,” for utilizing the elastic button user interface in the second messaging application environment after the elastic button release, in accordance with an embodiment of the invention. Once the user's finger releases the elastic button (703) on the touch-sensing display unit, a “final activation” user command is invoked through the elastic button user interface executed in the electronic device. In case of the second messaging application environment, the final activation user command is an actual transmission of the item (701 of FIG. 7), whose size was dynamically controlled by a vertical distance (i.e. VD3, VD4) and whose shape was dynamically controlled by a horizontal distance (i.e. HD1, HD2) between the elastic button (703) and its initial or equilibrium position, until the release of the elastic button (703) from the user's finger.

Furthermore, as shown in “Sequence B6” in FIG. 9, a finalized size and a finalized shape of the item (701 of FIG. 7) for the actual transmission to another electronic device is determined by the last position of the elastic button (703) prior to its release. In this particular embodiment of the invention, the horizontal distance (i.e. HD1, HD2) of the elastic button (703) dynamically controls the facial expression or the shape of the item (701 of FIG. 7), while the vertical distance (i.e. VD3, VD4) of the elastic button (703) dynamically controls the size of the item (701 of FIG. 7). In other embodiments of the invention, other desired user commands may be associated with the vertical distance and the horizontal distance of the elastic button (703) relative to its initial or equilibrium position for dynamic real-time control of the item (701 of FIG. 7) prior to the elastic button release.

When the actual transmission of the item (701 of FIG. 7), with the finalized shape and the finalized size, is completed to another electronic device, the second messaging application environment that integrated the elastic button user interface displays a checkmark with a timestamp (e.g. “23:28”) to indicate a successful transmission of the message containing the finalized shape and the finalized size of the item (701 of FIG. 7). The final activation user command, which is a user command to transmit a selected message in this embodiment, is typically predefined and implemented by a user interface designer prior to integration of the elastic button user interface to the electronic device. However, in some embodiments of the invention, the user may be able to customize a desired user command and associate the customized user command with the user's finger release from the elastic button.

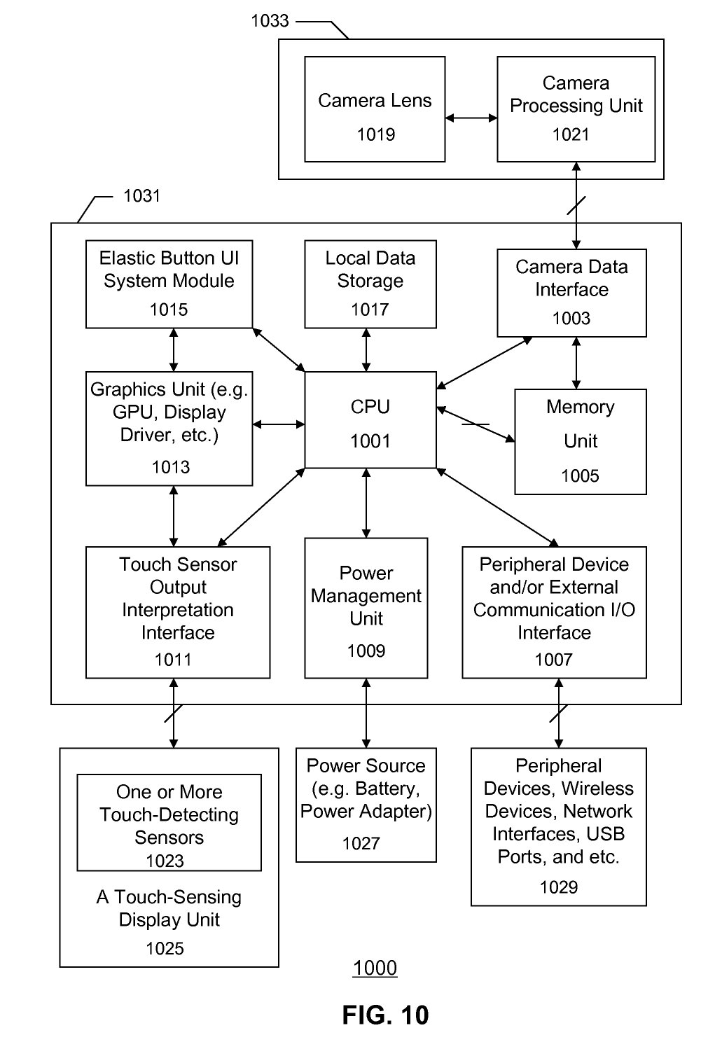

FIG. 10 shows a hardware system block diagram (1000) for an elastic button user interface system, in accordance with an embodiment of the invention. In a preferred embodiment of the invention, the elastic button user interface system provides an elastic button user interface on a touch-sensing display unit (1025) with an elastic button suspended on one or more strings that are anchored by one or more anchoring menu buttons. The elastic button user interface system also provides two-dimensional (i.e. vertical and horizontal) action thresholds associated with the elastic button and a computerized application (e.g. a camera viewfinder application, a messaging application, etc.) that integrates the elastic button user interface. The elastic button user interface system may be part of a smart phone, a tablet computer, or a specialized application-specific portable electronic device custom-built for integration of the elastic button user interface.

As shown in FIG. 10, the hardware system block diagram (1000) for the elastic button user interface system comprises a touch sensor output interpretation interface (1011), a touch-sensing display unit (1025) connected to the touch sensor output interpretation interface (1011), one or more touch-detecting sensors (1023) incorporated into the touch-sensing display unit (1025), and an elastic button user interface (UI) system module (1015). Furthermore, the elastic button user interface system may also include a CPU (1001), a camera data interface (1003), a memory unit (1005), a peripheral device and/or external communication input/output (I/O) interface (1007), a power management unit (1009), a graphics unit (1013), and a local data storage (1017). In addition, as shown in the hardware system block diagram (1000) in FIG. 10, the elastic button user interface system may also include a camera module (1033) comprising a camera processing unit (1021) and a camera lens (1019). In some embodiments of the invention, the elastic button user interface system may also integrate a wireless transceiver module and a digital signal processing (DSP) unit to enable wireless communication with another electronic device via a cellular network or another wireless network.

In one embodiment of the invention, the elastic button UI system module (1015) is configured to create an elastic button user interface comprising an elastic button suspended on one or more strings, which are anchored by corresponding anchoring menu buttons, as previously shown in FIGS. 1˜3 and FIGS. 5˜9. The elastic button UI system module (1015) is also configured to integrate and overlay the elastic button user interface on compatible computerized applications, such as a digital camera viewfinder application and a messaging application. Furthermore, the elastic button UI system module (1015) can create a multiple number of vertical and/or horizontal action thresholds that can be interpreted as specific user commands upon dragging of the elastic button from its initial or equilibrium position to a vertical distance (e.g. VD1, VD2, VD3, VD4) and/or a horizontal distance (e.g. HD1, HD2). Output values from the elastic button UI system module (1015) can be encoded by the graphics unit (1013) and/or the touch sensor output interpretation interface (1011) to position, configure, and display the elastic button user interface on the touch-sensing display unit (1025).

In addition, the elastic button UI system module (1015) also enables an application designer or a user to define and associate specific user commands with the multiple number of vertical and/or horizontal action thresholds for dynamic real-time transformation (e.g. size, shape) of a selected item or a selected view in the elastic button user interface. Moreover, a “final activation” for the selected item or the selected view, which is triggered by the elastic button release, may also be associated with a desired user command (e.g. activating a camera shutter button, initiating a transmission of a selected message, etc.) by configuring, controlling, and/or programming the elastic button UI system module (1015). The elastic button UI system module (1015) may be hard-coded and exist as an application-specific semiconductor chip or a field programming gate array. Alternatively, the elastic button UI system module (1015) may be implemented as codes resident in a non-volatile memory unit or another data storage unit that can be retrieved by the CPU (1001).

Continuing with FIG. 10, the touch-detecting sensors (1023) incorporated or embedded in the touch-sensing display unit (1025) detect a user's current finger position on the touch-sensing display unit (1025), and generates electrical outputs that are interpreted by the touch sensor output interpretation interface (1011). The touch sensor output interpretation interface (1011) may convert or transform raw electrical outputs from the touch-detecting sensors (1023) into a digital bit stream or other formats readily decodable by other logical units in the hardware system block diagram (1000). Then, the CPU (1001), the graphics unit (1013), and/or the elastic button UI system module (1015) are able to decode or decipher transformed or converted sensor values from the touch sensor output interpretation interface (1011).

Furthermore, in one embodiment of the invention, the camera processing unit (1021) in the camera module (1033) is capable of controlling the camera lens (1019) and camera shutter activations based on commands received from the CPU (1001) in the hardware system block diagram (1000) for the elastic button user interface system. The camera processing unit (1021) may also supply electrical power to the camera lens (1019). In addition, the camera processing unit (1021) may also provide some preliminary processing of raw multimedia data captured from the camera lens (1019). Examples of preliminary processing of raw multimedia data include image noise filtering, noise suppression, and other beneficial real-time adjustments. The camera data interface (1003) and the CPU (1001) can then further process and transform the raw multimedia data into processed multimedia data in a standardized format, such as JPEG or MPEG.

Furthermore, in one embodiment of the invention, a main logical area (1031) contains a plurality of logical units, such as the CPU (1001), the camera data interface (1003), the memory unit (1005), the peripheral device and/or external communication I/O interface (1007), the power management unit (1009), the touch sensor output interpretation interface (1011), the graphics unit (1013), the elastic button UI system module (1015), and the local data storage (1017). These logical units may be placed on a single printed circuit board in one embodiment of the invention, or on a plurality of printed circuit boards in another embodiment of the invention.

Moreover, in the embodiment of the invention as shown in FIG. 10, the CPU (1001) is configured to control each logical unit operatively (i.e. directly or indirectly) connected to the CPU (1001). The memory unit (1005) typically comprises volatile memory banks based on DRAM's. In some embodiments of the invention, the memory unit (1005) may use non-volatile memory technologies such as SRAM's and/or Flash memory. The memory unit (1005) is capable of storing or uploading programs and applications which can be executed by the CPU (1001), the graphics unit (1013), or another logical unit operatively connected to the memory unit (1005).

In addition, as shown in FIG. 10, the peripheral device and/or external communication I/O interface (1007) may be operatively connected to a wireless transceiver and an radio frequency (RF) antenna for wireless data access via a cloud network. The peripheral device and/or external communication I/O interface (1007) can also be operatively connected to a plurality of wireless or wired electronic devices (1029) via a data network and/or a direct device-to-device connection method. Moreover, the power management unit (1009) is operatively connected to a power supply unit and a power source (e.g. battery, power adapter) (1027), and the power management unit (1009) generally controls power supplied to various logical units in the elastic button user interface system.

Furthermore, in one embodiment of the invention, the graphics unit (1013) in the hardware system block diagram (1000) comprises a graphics processor, a display driver, a dedicated graphics memory unit, and/or another graphics-related logical components. In general, the graphics unit (1013) is able to process and communicate graphics-related data with the CPU (1001), the display driver, and/or the dedicated graphics memory unit. The graphics unit (1013) is also operatively connected to the touch-detecting sensors (1023) and the touch-sensing display unit (1025).

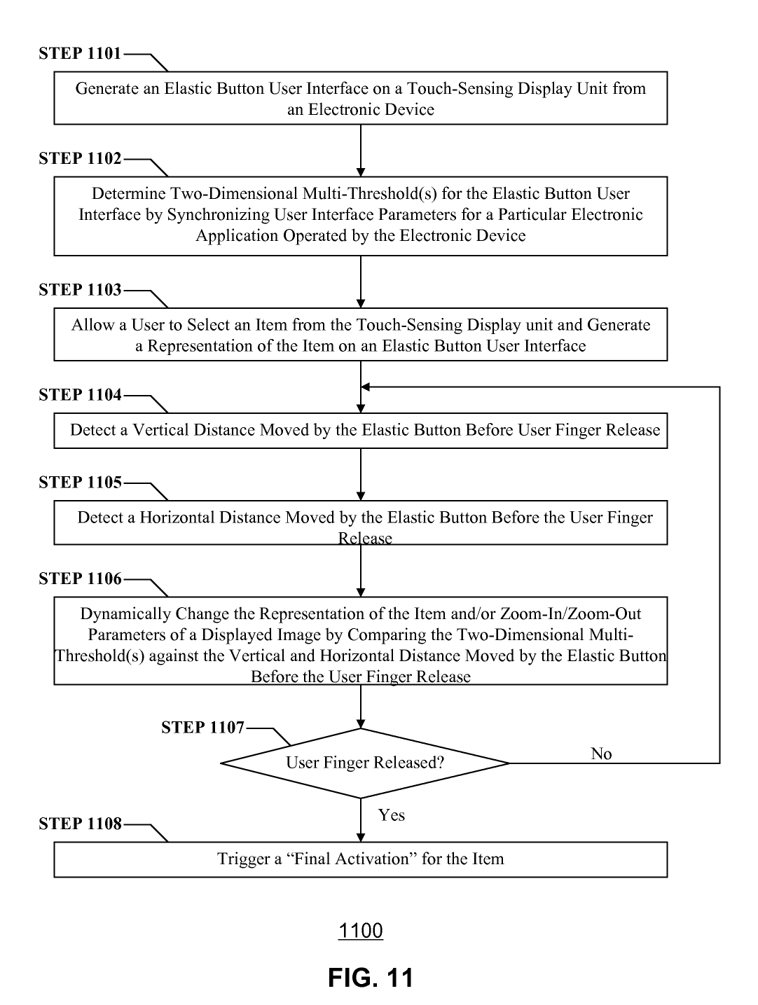

FIG. 11 shows a method flowchart (1100) for operating an elastic button user interface system, in accordance with an embodiment of the invention. First, the elastic button user interface system generates an elastic button user interface on a touch-sensing display unit associated with an electronic device, as shown in STEP 1101. In one embodiment, an elastic button user interface (UI) system module implemented in the electronic device creates, configures, and manages the elastic button user interface on the touch-sensing display unit. Then, as shown in STEP 1102, the elastic button user interface system determines two-dimensional (i.e. vertical and horizontal) multiple action thresholds for the elastic button user interface by synchronizing user interface parameters for a particular electronic application operated by the electronic device. For example, the elastic button user interface (UI) system module can create and configure the user interface parameters for a digital camera viewfinder application or a messaging application. The user interface parameters may include, but are not limited to, functionalities of anchoring menu buttons, lengths and appearances of strings suspending an elastic button, configurable shapes and sizes for the elastic button, vertical distances (e.g. VD1, VD2, VD3, VD4) associated with one or more action thresholds, and horizontal distances (e.g. HD1, HD2) associated with one or more action thresholds.

Subsequently, the elastic button user interface system allows a user to select an item from the touch-sensing display unit and generate a representation of the item on or inside the elastic button, which is typically suspended by one or more strings and anchored by one or more anchoring menu buttons, as shown in STEP 1103. Then, the elastic button user interface system detects a vertical distance moved by the elastic button before the user's finger release, as shown in STEP 1104. Similarly, the elastic button user interface system also detects a horizontal distance moved by the elastic button before the user's finger release, as shown in STEP 1105. The moved distance detection is typically achieved through touch-detecting sensors embedded in the touch-sensing display unit and the elastic button user interface system module operatively connected to a graphics unit, a touch sensor output interpretation interface, and the touch-sensing display unit.

Continuing with the method flowchart (1100) in FIG. 11, after detecting the vertical distance moved and the horizontal distance moved by the elastic button, the elastic button user interface system then dynamically changes the representation of the item and/or magnification (i.e. zoom-in/zoom-out) parameters of a displayed image by comparing the two-dimensional multi-thresholds against the vertical and horizontal distance(s) moved by the elastic button before the user's finger release, as shown in STEP 1106. Then, the elastic button user interface system checks whether the user's finger is released, as shown in STEP 1107. If the user's finger is not released, then the elastic button user interface system loops back to STEP 1104 to continue to detect the vertical and horizontal distances moved by the elastic button and to change the representation of the item and the magnification parameters of the displayed image before the user's finger release. On the other hand, if the user's finger is released, then the elastic button user interface system triggers a “final activation” for the item, as shown in STEP 1108. As an example, the final activation may be activating a camera shutter button to capture a photograph, transmitting a selected message, or another desired user command associated with a particular application executed in the electronic device.

Various embodiments of the present invention provide several advantages over conventional gesture user input or gesture navigation methods. For example, a novel elastic button user interface system in accordance with one or more embodiments of the present invention enables a user to perform a multiple number of tasks with a coherent sequence of intuitive finger gestures. Furthermore, the novel elastic button user interface system in accordance with one or more embodiments of the present invention empowers the user with a coherent sequence of intuitive and time-efficient finger gestures by simulating a fluid and elastic motion of a button suspended on an elastic string.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An elastic button user interface system comprising:
a touch-sensing display unit;
one or more touch-detecting sensors embedded in the touch-sensing display unit;
a touch sensor output interpretation interface operatively connected to the touch-sensing display unit;
a graphics unit operatively connected to the touch sensor output interpretation interface and the touch-sensing display unit; and
an elastic button user interface system module operatively connected to the graphics unit, the touch sensor output interpretation interface, and the touch-sensing display unit, wherein the elastic button user interface system module creates, adjusts, and manages an elastic button user interface comprising an anchoring menu button, an elastic string anchored by the anchoring menu button, an elastic button suspended on the elastic string, and one or more vertical and horizontal distance action thresholds that trigger user commands to an electronic application environment that integrated the elastic button user interface when the elastic button is dragged or released by a user's finger on the touch-sensing display unit.

2. The elastic button user interface system of claim 1, further comprising a central processing unit, a memory unit, a camera data interface, a camera processing unit, and a camera lens.

3. The elastic button user interface system of claim 1, further comprising a power management unit, a power source connected to the power management unit, a peripheral device and external communication interface, and one or more peripheral devices, wireless devices, and network interfaces connected to the peripheral device and external communication interface.

4. The elastic button user interface system of claim 1, further comprising a digital signal processor and a wireless transceiver unit.

5. The elastic button user interface system of claim 1, wherein the elastic button created and managed by the elastic button user interface system module is configured to select an item in the electronic application environment and transform a size or shape of the item by dragging the elastic button horizontally or vertically to reach the one or more vertical and horizontal distance action thresholds, before releasing the user's finger on the elastic button.

6. The elastic button user interface system of claim 5, wherein the elastic button released by the user's finger triggers a final activation for the item in the electronic application environment.

7. The elastic button user interface system of claim 6, wherein the electronic application environment is a messaging application environment, and wherein the final activation for the item is an electronic transmission of the item to another electronic device.

8. The elastic button user interface system of claim 1, wherein the elastic button created and managed by the elastic button user interface system module is configured to change magnification parameters for a digital camera viewfinder of the electronic application environment by dragging the elastic button horizontally or vertically to reach the one or more vertical and horizontal distance action thresholds, before releasing the user's finger on the elastic button.

9. The elastic button user interface system of claim 8, wherein the elastic button released by the user's finger triggers a camera shutter button activation to capture a photograph in the digital camera viewfinder of the electronic application environment.

10. The elastic button user interface system of claim 9, wherein the electronic application environment is a digital camera application environment.

11. A method of operating an elastic button user interface system, the method comprising the steps of:
generating an elastic button user interface from an elastic button user interface system module and a graphics unit incorporated in the elastic button user interface system by creating an anchoring menu button, an elastic string anchored by the anchoring menu button, and an elastic button suspended on the elastic string on a touch-sensing display unit;
creating, with the elastic button user interface system module, two-dimensional vertical and horizontal action thresholds for the elastic button user interface by synchronizing user interface parameters for a particular electronic application in the elastic button user interface system;
allowing a user to select an item from the touch-sensing display unit;
allowing the user to drag the elastic button suspended on the elastic string;
detecting, with touch-detecting sensors embedded in the touch-sensing display unit and the elastic button user interface system module, a vertical distance and a horizontal distance moved by the elastic button before the user's finger release;
dynamically changing a size or shape of the item or magnification parameters of a displayed image on the touch-sensing display unit by comparing the two-dimensional vertical and horizontal action thresholds against the vertical distance and the horizontal distance moved by the elastic button before the user's finger release; and
if the user's finger release is detected by the touch-detecting sensors and the elastic button user interface systems module, triggering a final activation for the item.

12. The method of claim 11, further comprising a step of generating a graphical representation of the item inside the elastic button or on a particular section of the touch-sensing display unit.

13. The method of claim 11, wherein the final activation for the item is an electronic transmission of the item to another electronic device, or a camera shutter button activation to capture a photograph in a digital camera viewfinder of the particular electronic application in the elastic button user interface system.
